(19) United States
(12) Patent Application Publication
(10) Pub. No.: US 2001/0018121 A1
(43) Pub. Date: Aug. 30, 2001

(54) Polymeric foam processing

(76) Inventors: Kelvin T. Okamoto, Boston, MA (US); Liqin Chen, West Roxbury, MA (US); Theodore A. Burnham, Belmont, MA (US); Richard S. Straff, Marblehead, MA (US)

Correspondence Address: Timothy J. Oyer, Wolf, Greenfield & Sacks, P.C., 600 Atlantic Avenue, Boston, MA, 02210, US

(21) Appl. No.: 09/817,511

(22) Filed: Mar. 26, 2001

Related U.S. Application Data
(62) Division of application No. 09/321,472, filed on May 27, 1999.

(51) Int. Cl. B32B 3/00

(52) U.S. Cl. 428/315.7; 428/318.8; 264/51; 425/376.1; 425/461; 521/51

(57) ABSTRACT

The present invention provides microcellular articles, as well as methods and apparatuses for producing polymeric foams, and, in particular microcellular material. The methods involve forming a gas blanket within a polymer processing die that prevents contact between the polymer melt and surfaces of the die during extrusion. In one set of embodiments, the gas blanket is provided by gas diffusing out of surfaces of the nucleated polymer material. In other embodiments, the gas blanket is formed by introducing a gas from an external source into the polymer flow channel within the die. The dies, according to the invention, are specially configured to generate and to support the gas blanket. The extruded foams are free of surface defects that, typically, arise from contact between the polymer melt and the die surfaces.

### FIELD OF INVENTION

The present invention relates generally to polymeric foam processing, and more particularly to microcellular foam processing.

### BACKGROUND OF THE INVENTION

Polymeric foams include a plurality of voids, also called cells, in a polymer matrix. The foams are typically produced by introducing a physical blowing agent into a molten polymeric stream, mixing the blowing agent with the polymer, and extruding the mixture into the atmosphere while shaping the mixture. Exposure to atmospheric conditions causes the blowing agent to gasify, thereby forming cells in the polymer. As an alternative to a physical blowing agent, a chemical blowing agent can be used which undergoes chemical decomposition in the polymer material causing formation of a gas.

Microcellular foams have smaller cell sizes and higher cell densities than conventional polymeric foams. Typically, microcellular foams are defined as having average cell sizes of less than 100 microns and/or a cell density of greater than 10⁶ cells/cm³ of solid plastic. Microcellular plastics can be produced in a variety of ways including a continuous extrusion process. The extrusion process, generally, involves injecting a blowing agent into the polymer melt in an extruder, creating a single-phase solution of polymeric material and blowing agent, dropping the pressure of the solution to nucleate a plurality of cells in the polymer, shaping and cooling the extrudate to form a microcellular product.

Several patents describe aspects of polymeric foams, and in particular, microcellular materials and microcellular processes.

U.S. Pat. No. 3,796,779 (Greenberg; Mar. 12, 1976) describes injection of a gas into a flowing stream of molten plastic, and expansion to produce a foam. The described technique typically produces voids or cells within the plastic that are relatively large, for example on the order of 100 microns or greater. The number of voids or cells per unit volume of material typically is relatively low according to the technique and often the material exhibits a non-uniform distribution of cells throughout the material. Therefore, thin sheets and sheets having very smooth finishes typically cannot be made by the technique, and materials produced typically have relatively low mechanical strengths and toughness.

U.S. Pat. No. 4,473,665 (Martini-Vvedensky, et al.; Sep. 25, 1984) describes a process for making foamed polymer having cells less than about 100 microns in diameter. In a technique of Martini-Vvedensky et al., a material precursor is saturated with a blowing agent, the material is placed under high pressure, and the pressure is rapidly dropped to nucleate the blowing agent and to allow the formation of cells. The material then is frozen rapidly to maintain a desired distribution of microcells.

U.S. Pat. No. 5,158,986 (Cha, et al.; Oct. 27, 1992) describes formation of microcellular polymeric material using a supercritical fluid as a blowing agent. In a batch process of Cha, et al., a plastic article is submerged at pressure in supercritical fluid for a period of time, and then quickly returned to ambient conditions creating a solubility change and nucleation. In a continuous process, a polymeric sheet is extruded, and then can be run through rollers in a container of supercritical fluid at high pressure, and then exposed quickly to ambient conditions. In another continuous process, a supercritical fluid-saturated molten polymeric stream is established. The stream is rapidly heated, and the resulting thermodynamic instability (solubility change) creates sites of nucleation, while the system is maintained under pressure preventing significant growth of cells. The material then is injected into a mold cavity where pressure is reduced and cells are allowed to grow.

International patent publication no. WO 98/08667 (Burnham et al.) provides methods and systems for producing microcellular material, and microcellular articles. In one method of Burnham et al., a fluid, single-phase solution of a precursor of foamed polymeric material and a blowing agent is continuously nucleated by dividing the stream into separate portions and separately nucleating each of the separate portions. The divided streams can be recombined into a single stream of nucleated, fluid polymeric material. The recombined stream may be shaped into a desired form, for example, by a shaping die. Burnham et al. also describes a die for making advantageously thick microcellular articles, that includes a multiple pathway nucleation section. Other methods describe the fabrication of very thin microcellular products, as well. In particular, a method for continuously extruding microcellular material onto a wire, resulting in very thin essentially closed cell microcellular insulating coating secured to the wire, is provided. In some of the methods, pressure drop rate is an important feature and techniques to control this and other parameters are described.

In another embodiment of Burnham et al., an annular die is provided useful in the production of uncorrugated microcellular sheet. The die includes a first annular section that has a constant radius and a constant gap dimension of a size selected to define a nucleating pathway. The die also includes a more downstream annular section that is of a radius that increases in a downstream direction which also includes a constant gap dimension. During operation, the polymer and blowing agent solution is nucleated when passed through the nucleating gap and the nucleating material is allowed to grow in the more downstream annular section. Because the more downstream section includes a constant width gap, the growth of the sheet can occur only laterally. Lateral growth of the sheet is permitted due to the constantly increasing radius of the more downstream annular section which allows lateral growth without resulting in sheet corrugation.

While the above and other reports represent several techniques associated with the manufacture of polymeric foams, and in particular microcellular material, there is a need in the industry for processes that produce polymeric foams and microcellular material having high quality surface characteristics.

### SUMMARY OF THE INVENTION

The present invention provides microcellular articles, as well as methods and apparatuses for producing polymeric foams, and, in particular microcellular material. The methods involve forming a gas blanket within a polymer processing die that prevents contact between the polymer melt and surfaces of the die during extrusion. In one set of embodiments, the gas blanket is provided by gas diffusing out of surfaces of the nucleated polymer material. In other embodiments, the gas blanket is formed by introducing a gas from an external source into the polymer flow channel within the die. The dies, according to the invention, are specially configured to generate and to support the gas blanket. The extruded foams are free of surface defects that, typically, arise from contact between the polymer melt and the die surfaces.

In one aspect, the invention provides a method of forming a polymeric article. The method includes forming a solution of polymer melt and blowing agent within a polymer processing space between a processing screw and a barrel of an extruder. The method further includes extruding the solution of polymer and blowing agent through a die having a passageway, defined by internal die surfaces, fluidly connected to the polymer processing space while forming a gas blanket that separates the polymer melt from at least a portion of the internal die surfaces at an outlet of the die.

In another aspect, the invention provides a method of forming a polymeric article. The method includes forming a solution of polymer melt and blowing agent within a polymer processing space between a processing screw and a barrel of an extruder. The method further includes extruding, through a die outlet of the extruder, a polymeric article in the shape of an extrudate corresponding to the shape of the die outlet by maintaining pressure on an exterior surface of the polymer melt within the die and then releasing the pressure as the polymer melt exits the die outlet and hardens to form the extrudate, without allowing the polymer melt to contact interior surfaces of the die within 1 cm of the die outlet.

In another aspect, the invention provides a polymer processing die. The die includes an inlet designed to receive a solution of polymer melt and blowing agent from an outlet of an extruder. The die also includes a nucleating passageway fluidly connected to the inlet having dimensions designed to nucleate the solution of polymer melt and blowing agent. The die also includes an exit passageway fluidly connected to the nucleating pathway having dimensions designed to support a gas blanket between surfaces defining the exit passageway and surfaces of the nucleated polymer melt.

In another aspect, the invention provides a polymer processing die. The die includes a die inlet positionable in relation to an outlet of an extruder to receive a single-phase solution of polymer melt and blowing agent from the extruder outlet. The die also includes a die outlet and a passageway connecting the die inlet with the die outlet. The passageway includes a first, upstream portion defining a nucleating pathway having a cross-sectional area and length designed to nucleate the solution of polymer melt and blowing agent and a second, downstream portion, between the first portion and the die outlet, of a second cross-sectional area greater than the first cross-sectional area. The second cross-sectional area is selected such that under conditions of flow of the single-phase solution of polymer melt and blowing agent within the nucleating pathway set to nucleate the single-phase solution, a gas blanket is formed between surfaces defining the interior surface of the second portion and surfaces of the nucleated polymer melt of sufficient pressure to confine the polymer melt and to prevent contact between the polymer melt and the interior surface of the second section.

The invention also provides an article including a microcellular material having an average cell size of less than 100 microns and a variation of cell size across the cross-section of the material of less than 20% of the average cell size. The material includes a skin layer having a thickness of less than 1 micron defining an outer surface of the material.

Among other advantages, the invention provides a method of producing foam articles, and especially microcellular articles, with an ultra-smooth surface essentially free of defects. Such articles are particularly well-suited for printing because the majority of the applied ink remains on the surface, as opposed to accumulating within surface defects, and thus the printed images are very well-defined. Furthermore, the ultra-smooth surfaces can lead to improvements when the foams are laminated. For instance, higher line speeds during the lamination step and improved foam-laminate adhesion are envisioned due to increases in the foam surface area in contact with the laminate.

In addition, the invention provides foam articles having a uniform cell size across the entire cross-section of the foam. The present process avoids problems associated with typical processes such as cell rupture and agglomeration near the foam surface and non-uniform cell sizes across the foam cross-section which may adversely effect the properties of the foam. The uniform cell structure of the foam articles according to the invention leads to excellent mechanical properties, in particular, tensile and compressive properties.

The invention also provides foam articles having a thin skin layer. In certain applications, the thin skin advantageously provides flexibility for the foam article.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other advantages, novel features, and aspects of the invention will become apparent from the following detailed description of the invention when considered in conjunction with the accompanying figures, and from the claims.

### BRIEF DESCRIPTION OF THE DRAWINGS

FIG. 1 schematically illustrates an extrusion system for producing microcellular foam.

FIG. 2 schematically illustrates a multi-hole blowing agent feed orifice arrangement and extrusion screw.

FIG. 3 schematically illustrates a polymer processing die of the invention suitable for generating and supporting a gas blanket.

FIG. 4 schematically shows the extrusion of polymeric material from a die using a gas blanket.

FIG. 5 schematically illustrates a polymer processing die suitable for generating and supporting a gas blanket according to another embodiment of the invention.

FIGS. 6 and 6A respectively and schematically illustrate a polymer processing die arranged in a first position to permit and a second position to prevent gas flow from an external source into a passageway within the die according to another embodiment of the invention.

FIG. 7 is a photocopy of an SEM photograph of the surface of the material produced in Example 2.

FIG. 8 is a photocopy of an SEM photograph of the cross-section of the material produced in Example 2.

FIG. 9 is a photocopy of an SEM photograph of the surface of the material produced in Example 3.

FIG. 10 is a photocopy of an SEM photograph of the cross-section of the material produced in Example 3.

FIG. 11 is a photocopy of an SEM photograph of the surface of the material produced in Example 5.

FIG. 12 is a photocopy of an SEM photograph of the surface of the material produced in Example 6.

### DETAILED DESCRIPTION OF THE INVENTION

Commonly-owned, co-pending International patent publication serial no. WO 98/08667 filed Aug. 26, 1997 is incorporated herein by reference.

The various embodiments and aspects of the invention will be better understood from the following definitions. A “microcellular foam” or “microcellular material” is defined as a foamed material having an average cell size of less than about 100 microns in diameter or material of cell density of generally greater than at least about 10⁶ cells/cm³ of unfoamed plastic, or preferably both. A “conventional foam” is defined as a foamed material that is not a “microcellular foam”. As used herein, “nucleation” defines a process by which a homogeneous, single-phase solution of polymeric material, in which is dissolved molecules of a species that is a gas under ambient conditions, undergoes formations of clusters of molecules of the species that define “nucleation sites”, from which cells will grow. That is, “nucleation” means a change from a homogeneous, single-phase solution to a multi-phase mixture in which, throughout the polymeric material, sites of aggregation of at least several molecules of blowing agent are formed.

The methods and apparatuses of the invention are useful in the production of either microcellular polymeric material or conventional polymeric foam. In certain embodiments, microcellular material of the invention is produced having average cell size of less than about 50 microns, and in other cases less than about 30 microns. The microcellular material, in certain cases, preferably has a maximum cell size of about 100 microns. In embodiments where particularly small cell size is desired, the material can have maximum cell size of about 50 microns, more preferably about 40 microns, and more preferably still about 30 microns. A set of embodiments includes all combinations of these noted average cell sizes and maximum cell sizes. For example, one embodiment in this set of embodiments includes microcellular material having an average cell size of less than about 30 microns with a maximum cell size of about 50 microns, and as another example an average cell size of less than about 30 microns with a maximum cell size of about 35 microns, etc. That is, microcellular material designed for a variety of purposes can be produced having a particular combination of average cell size and a maximum cell size preferable for that purpose.

In preferred embodiments, the cell size across the cross-section of the foam article is substantially uniform. That is, the cell size across the cross-section of the article generally varies by less than 20 percent of the average cell size. For example, in these embodiments, articles having an average cell size of 50 microns generally include a variation in cell size of at most ±10 micron, thus, such articles generally include cells between 40 microns and 60 microns. In these embodiments, the articles may include a limited number (less than 1%) of large or small cells (e.g. cells having a size that varies from the average cell size by greater than 20 percent) which are anomalous, rather than indicative of a non-uniform cell structure.

The cell structure of the microcellular material, preferably, is a closed cell structure. A substantially closed cell structure has limited interconnection between adjacent cells and generally, is meant to define material that, at a thickness of about 100 microns, contains no connected cell pathway through the material. It is believed that the closed cell structure may, advantageously, enhance mechanical properties due to the absence of a long inner connected pathway which could act as a stress concentration site. In particular, the cell structure near the surfaces of the material are generally not ruptured. In typical processes, that do not utilize a gas blanket, cell rupture may occur due to frictional forces between the die surfaces and the polymer melt during extrusion. This is avoided in the techniques of the present invention.

The microcellular material of the invention generally includes cell densities of greater than about 10⁶ cells/cm³ of unfoamed plastic. In certain embodiments, the microcellular material includes a cell density of greater than about 10⁷ cells/cm³, and in some cases greater than 10⁸ cells/cm³, and in still other cases, greater than about 10⁹ cells/cm³.

The foam articles (microcellular and conventional) of the present invention can be produced over a broad density range as required by their end use. The density, and thus the void fraction, of the foam can be controlled by selecting appropriate processing parameters. In most cases, the foams have a void fraction of greater than 0.05 and less than 0.98. In one set of embodiments, low-density microcellular materials (preferably low-density microcellular polystyrene) are provided. In these embodiments, the microcellular materials have a void fraction of between 0.80 and 0.98, and in certain embodiments between 0.90 and 0.98, and in some embodiments between 0.95 and 0.98. In another set of embodiments, the microcellular materials (preferably polyvinyl chloride) have a mid-level density. In these embodiments, the microcellular materials have a void fraction of between 0.3 and 0.7.

The foam articles of the present invention can be produced over a wide range of thickness. Foams having a thickness of between 0.005 inches and 0.5 inches can be produced. The thickness is controlled by selecting appropriate processing parameters and using appropriately adjusted equipment dimensions (e.g. nucleating gap and exit gap). In particular, microcellular articles may be thin in cross-section due, in part, to the small cell sizes of these articles. Preferred foam thicknesses, in particular for low-density microcellular polystyrene, range from about 0.070 inches to about 0.250 inches.

In certain embodiments, the foam articles of the invention, particularly microcellular foam articles, also have a very thin outer skin that defines surfaces of the articles. In many cases, the skin has a thickness of less than 1 micron, in some cases less than 0.1 microns, and in other cases less than 0.05 microns.

Foam articles according to the invention have, in many embodiments, ultra-smooth surfaces. The surfaces are characterized by having a high gloss and are generally free of artifacts resulting from frictional forces between the polymer melt and the die surfaces during extrusion. Such artifacts can include surface tearing, pin holes in the surface, or cells that rupture through the surface. Because the processing of microcellular materials generally involves extruding polymer melt at low melt temperatures through thin cross-sections, frictional forces between the polymer melt and die surfaces are of particular concern. The present methods which utilize the gas blanket, thus, have noticeably improved surfaces upon visual inspection than microcellular materials produced without the gas blanket. In many cases, the improvement in surface smoothness can readily be felt by the touch of a hand.

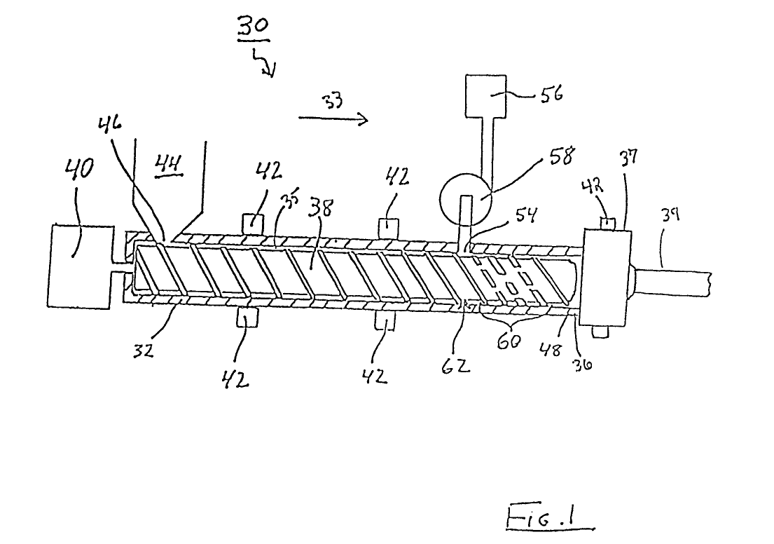

Referring to FIG. 1, one embodiment of an extrusion system for the production of polymeric foam in accordance with the invention is illustrated schematically. An extrusion system 30 includes a screw 38 that rotates within a barrel 32 to convey, in a downstream direction 33, polymeric material in a processing space 35 between the screw and the barrel. The polymeric material is extruded through a die 37 fluidly connected to processing space 35 and fixed to a downstream end 36 of barrel 32. Die 37 is configured to generate and support a gas blanket that separates the polymeric material from surfaces within the die during the extrusion process to form an extrudate 39 having an ultra-smooth surface, as described further below.

Extrusion screw 38 is operably connected, at its upstream end, to a drive motor 40 which rotates the screw. Although not shown in detail, extrusion screw 38 includes feed, transition, gas injection, mixing, metering and cooling sections. Positioned along extrusion barrel 32, optionally, are temperature control units 42. In some embodiments, the temperature control units 42 are also positioned on die 37. Control units 42 can be electrical heaters, can include passageways for temperature control fluid, or the like.

Units 42 can be used to heat a stream of pelletized or fluid polymeric material within the extrusion barrel to facilitate melting, and/or to cool the stream to control viscosity, skin formation and, in some cases, blowing agent solubility. The temperature control units can operate differently at different locations along the barrel, that is, to heat at one or more locations, and to cool at one or more different locations. Any number of temperature control units can be provided.

Extrusion barrel 32 is constructed and arranged to receive a precursor of a fluid polymeric material. Amorphous, semicrystalline, and crystalline material including polyolefins such as polyethylene and polypropylene, fluoropolymers, crosslinkable polyolefins, polyamides, polyvinyl chloride, and polyaromatics such as styrenic polymers including polystyrene can be used. Typically, this involves a standard hopper 44 for containing pelletized polymeric material to be fed into the extruder barrel through orifice 46, although a precursor can be a fluid prepolymeric material injected through an orifice and polymerized within the barrel via, for example, auxiliary polymerization agents.

The blowing agent is introduced into the polymer stream through a port 54 in fluid communication with a source 56 of a physical blowing agent. The port can be positioned to introduce the blowing agent at any of a variety of locations along the extrusion barrel 32. Preferably, as discussed further below, the port introduces blowing agent at the gas injection section of the screw, where the screw includes multiple flights.

Any of a wide variety of blowing agents known to those of ordinary skill in the art such as hydrocarbons, chlorofluorocarbons, nitrogen, carbon dioxide, and the like can be used in connection with this embodiment of the invention and, according to a preferred embodiment, source 56 provides carbon dioxide as a blowing agent. In another preferred embodiment, source 56 provides nitrogen as a blowing agent. In particularly preferred embodiments solely carbon dioxide or nitrogen is respectively used. A pressure and metering device 58 typically is provided between blowing agent source 56 and port 54. Blowing agents that are in the supercritical fluid state in the extruder are especially preferred, in particular supercritical carbon dioxide and supercritical nitrogen.

Device 58 can be used to meter the blowing agent so as to control the amount of the blowing agent in the polymeric stream within the extruder to maintain a level of blowing agent. In a preferred embodiment, device 58 meters the mass flow rate of the blowing agent. The blowing agent is generally less than about 15% by weight of polymeric stream and blowing agent. When processing polystyrene, preferably greater than about 5%, and more preferably greater than about 6%, carbon dioxide by weight of polymeric stream and blowing agent is used. When processing polyvinyl chloride, preferably between 1% and 4% of carbon dioxide by weight of polymeric stream and blowing agent. In most embodiments, when nitrogen is used the blowing agent levels are lower than when carbon dioxide is used. In some embodiments, talc may be used as a nucleating agent which permits using lower levels of blowing agent.

The pressure and metering device can be connected to a controller (not shown) that also is connected to drive motor 40 and/or a drive mechanism of a gear pump (not shown) to control metering of blowing agent in relationship to flow of polymeric material to very precisely control the weight percent blowing agent in the fluid polymeric mixture.

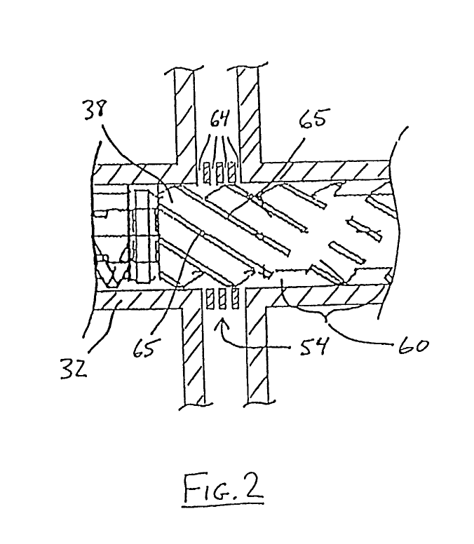

Referring now to FIG. 2, a preferred embodiment of the blowing agent port is illustrated in greater detail and, in addition, two ports on opposing top and bottom sides of the barrel are shown. In this preferred embodiment, port 54 is located in the gas injection section of the screw at a region upstream from mixing section 60 of screw 38 (including highly-broken flights) at a distance upstream of the mixing section of no more than about 4 full flights, preferably no more than about 2 full flights, or no more than 1 full flight. Positioned as such, injected blowing agent is very rapidly and evenly mixed into a fluid polymeric stream to promote production of a single-phase solution of the foamed material precursor and the blowing agent.

Port 54, in the preferred embodiment illustrated, is a multi-hole port including a plurality of orifices 64 connecting the blowing agent source with the extruder barrel. As shown, in preferred embodiments a plurality of ports 54 are provided about the extruder barrel at various positions radially and can be in alignment longitudinally with each other. For example, a plurality of ports 54 can be placed at the 12 o'clock, 3 o'clock, 6 o'clock, and 9 o'clock positions about the extruder barrel, each including multiple orifices 64. In this manner, where each orifice 64 is considered a blowing agent orifice, the invention includes extrusion apparatus having at least about 10, preferably at least about 40, more preferably at least about 100, more preferably at least about 300, more preferably at least about 500, and more preferably still at least about 700 blowing agent orifices in fluid communication with the extruder barrel, fluidly connecting the barrel with a source of blowing agent.

Also in preferred embodiments is an arrangement (as shown in FIG. 2) in which the blowing agent orifice or orifices are positioned along the extruder barrel at a location where, when a preferred screw is mounted in the barrel, the orifice or orifices are adjacent full, unbroken flights 65. In this manner, as the screw rotates, each flight, passes, or “wipes” each orifice periodically. This wiping increases rapid mixing of blowing agent and fluid foamed material precursor by, in one embodiment, essentially rapidly opening and closing each orifice by periodically blocking each orifice, when the flight is large enough relative to the orifice to completely block the orifice when in alignment therewith. The result is a distribution of relatively finely-divided, isolated regions of blowing agent in the fluid polymeric material immediately upon injection and prior to any mixing. In this arrangement, at a standard screw revolution speed of about 30 rpm, each orifice is passed by a flight at a rate of at least about 0.5 passes per second, more preferably at least about 1 pass per second, more preferably at least about 1.5 passes per second, and more preferably still at least about 2 passes per second. In preferred embodiments, orifices 54 are positioned at a distance of from about 15 to about 30 barrel diameters from the beginning of the screw (at upstream end 34).

Referring again to FIG. 1, screw 38, following the gas injection section, includes a mixing section having a series of unbroken flights which break up the stream to encourage mixing of the blowing agent and polymer stream. Preferably, a single-phase solution of the blowing agent and polymer stream is formed prior to die 37. As described further below, the polymer and blowing agent single-phase solution is conveyed from the polymer processing space into flow channels within the die.

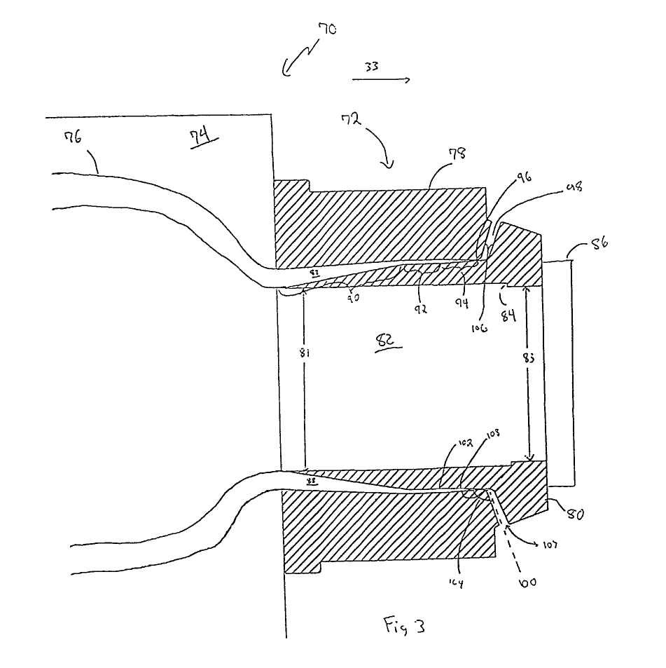

Referring to FIG. 3, an annular polymer processing die 70 according to an embodiment of the invention is schematically illustrated. Die 70 includes an annular die body 74 which is attachable to the downstream end of an extruder and an annular die lip section 72 that extends from the downstream end of the die body. The die lip section is composed of an outer die lip 78 and an inner die lip 80 which define therebetween an annular passageway 88 that is fluidly connected to polymer processing space 35 (FIG. 1) via a flow channel 76 in the die body. The outer die lip is fixed directly to the downstream end of the die body. A mandrel 82 is placed through an inner diameter 81 of the inner die lip and threaded into the downstream end of the die body to position the inner die lip relative to the outer die lip thereby defining the dimensions of the passageway. The inner die lip includes a section 83 having a reduced inner diameter which is fixed between a ledge 84 of the mandrel and a nut 86 threaded onto the downstream end of the mandrel. During operation, molten plastic pushes the inner die lip in a downstream direction against the nut.

The die is designed so that certain dimensions of passageway 88 can be adjusted, to an extent, in a simple manner. To change the dimensions of the pathway, the nut may be threaded further into or out of the mandrel to move the lower die lip in either an upstream or a downstream direction relative to the upper die lip. Other mechanisms exist for moving the upper and lower die lips relative to each other as known in the art. For example, the die may include a wheel or a counter which allows for precise control over the motion of inner die lip and the resulting dimensions of passageway 88.

The mandrel, optionally, includes internal passageways (not illustrated) through which a coolant can flow to lower its temperature, and accordingly, the temperature of the inner die lip. During microcellular processing, oftentimes, it is advantageous to cool the polymer melt by lowering the temperature of the die. The internal passageways in the mandrel are fluidly connected to an external chiller which circulates a fluid such as oil or water through the passageways to provide the temperature control.

Passageway 88 between the outer die lip and the inner die lip includes a series of annular sections having different functions across its length. Entrance section 90 of the passageway is connected at its upstream end to flow channel 76 within the die body. The entrance section is tapered to reduce the diameter of the passageway 88 from that of the flow channel. The dimensions of the entrance section, and in particular the taper angle, are selected as known in the art to minimize the turbulent flow of polymeric material through the die which is undesirable in the processing of polymer melts. Typically, the taper angle is selected to minimize turbulence depending upon processing parameters, as known in the art, that effect the viscosity of the melt such as flow rate, material type, melt temperature, and weight percent blowing agent.

Immediately downstream of the entrance section, passageway includes a pre-nucleator section 92. The pre-nucleator section is defined by respective parallel portions of the upper die lip and lower die lip to produce a straight land having a constant gap. The dimensions of the pre-nucleator section are selected, as known in the art, so as to remove any memory effects of the polymeric material from passing through converging entrance section 90 and to further eliminate turbulent flow. In typical designs, the length of the pre-nucleator section is 6 to 12 times the thickness of its gap.

Passageway 88 includes a nucleator section 94 immediately downstream of the pre-nucleator section. The nucleator section converges in a downstream direction across its entire length. That is, the gap and, hence, the cross-sectional area of the nucleator section decrease in a downstream direction. A nucleating exit gap 96 at the end of the nucleator section, thus, defines the minimum gap thickness. The convergence of the nucleator section creates an increasing pressure drop rate as polymeric material flows therethrough with the maximum pressure drop rate occurring when the polymeric material flows through the nucleator exit gap. The dimensions of the nucleator section are designed, as known in the art, to provide relatively high pressure drop rates which, as described further below, are useful for the formation of the gas blanket. In preferred embodiments, the nucleator section provides a pressure drop rate of at least greater than 0.5 GPa/s, in more preferred embodiments a pressure drop rate of at least 1.0 GPa/s, in other embodiments a pressure drop rate of at least 1.5 GPa/s, and in some embodiments a pressure drop rate of at least 2.0 GPa/s. Typical dimensions of the nucleator section of a 1¾ inch diameter die are a convergence angle between 2° and 8°, and a nucleator exit gap between 0.010 inch and 0.018 inch.

Immediately downstream of the nucleator section, passageway 88 includes an exit section 98 having dimension designed to support a gas blanket. The exit section is defined by surfaces 106 and includes an outlet 107 for releasing the extrudate to ambient. To support the gas blanket, as described further below, the gap of the exit section is considerably larger than the nucleating exit gap. The exit section gap is defined as the distance between the outer and inner die lip at the outlet. Typically, the exit section gap is between 0.10 inches and 0.20 inches, and the exit section has a length between 0.5 inches and 1.5 inches. In some cases, it is preferable to have the walls defining the exit section to be parallel to provide a constant gap across the length of the exit section. In other cases, it is preferable that the surfaces defining the exit section diverge, and in other cases that the surfaces defining the exit section converge (i.e. cross-sectional area of the exit section increases or decreases, respectively, in a downstream direction). Typically, the degree of convergence or divergence is very slight and, thus, the gap varies only slight across the length of the exit section.

The exit section of passageway 88 diverges from the nucleator section of the passageway to change the direction of the polymer melt flowing therethrough and, in particular, to prevent corrugation. An angle 104, typically, between about 105° and about 135° is formed between an axis 100 of the exit channel and an axis 102 defined by the nucleator section. The surfaces of the outer die lip are rounded to a radius 108 at the point of divergence. Generally, corrugation is prevented because the diverging exit channel leads to increasing the diameter of annular passageway 88 which permits lateral growth of the sheet. The divergent exit section is particularly useful in preventing corrugation during the production of low-density microcellular material, such as low-density microcellular polystyrene.

Other exit channel and radius geometries for controlling and maintaining the gas blanket are also envisioned by this invention.

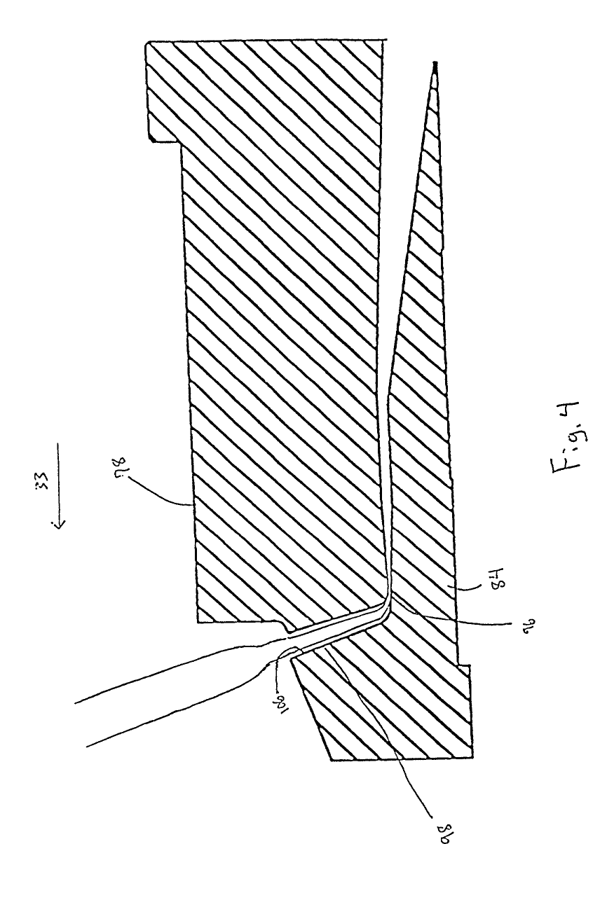

During a typical extrusion process, the polymeric material and blowing agent solution received by die 70 from the extruder flows via flow channel 76 into passageway 88 within die lip section 72 that includes the series of above-described annular sections. The solution passes in a downstream direction through entrance section 90, pre-nucleator section 92, and nucleator section 94. The pressure of the solution is rapidly dropped while passing through the nucleator section to reduce the solubility of the blowing agent in the polymer, thus, nucleating a plurality of microcells. Though it is believed that the solution of polymer and blowing agent is nucleated across the length of the nucleator section, the highest rate of cell nucleation occurs when the solution passes through the nucleator exit gap where the pressure drop rate is maximum. Immediately after passing through the nucleator exit gap, a percentage of the blowing agent diffuses out of the nucleated polymeric material in the form of a gas. The out-diffusing gas creates a gas blanket between the nucleated polymeric material and surfaces 106 of exit section 98 in systems of the invention because of the specific dimensions of the exit section relative to the nucleator section, as described further below. The gas blanket provides a pressure that forces the nucleated polymeric material away from surfaces 106, as illustrated schematically in FIG. 4. The gas blanket prevents contact between the nucleated polymeric material and at least the portion of the exit section surfaces 106. Preferably, the gas blanket prevents contact between the nucleated polymer melt along the entire length of the exit section surfaces as shown in FIG. 4. In some embodiments, the gas blanket prevents contact between the nucleated polymer melt and the exit section surfaces within 1 cm of outlet 107. At a minimum, the gas blanket prevents contact between the nucleated polymer melt and the exit section surfaces defining the exit gap. After passing through the exit channel, the extruded polymeric material, generally, further expands to its final thickness and density.

The gas blanket is formed in a continuous manner during extrusion processes in accordance with the invention. Because gas diffuses out of all surfaces of the nucleated polymer melt at essentially the same rate, the gas blanket is typically formed uniformly around the nucleated polymer melt. That is, the gas blanket is distributed homogeneously on either side of the polymer melt.

As described above, the nucleator section and the exit section are specifically designed to generate and support the gas blanket. In particular, the dimensions of the nucleator section are important in the formation of the gas blanket. The nucleator section is designed to converge, thus, creating a high pressure drop rate when polymeric material passes through the nucleator exit gap. The high pressure drop rate results in a rapid change in blowing agent solubility which enhances the out-diffusion of gas thereafter. The dimensions of the exit section are critical for supporting the gas blanket, that is sustaining the gas blanket so that it prevents contact between the polymer melt and the surfaces of the exit section. The exit section is designed to have a gap sized relative to the nucleator exit gap within a specific range. Generally, as described above, the exit section gap is between 5 and 20 times, and more preferably between 8 and 12 times, the nucleator exit gap to sufficiently support the gas blanket. If the exit section gap is too small relative to the nucleator exit gap then the out-diffusing gas does not provide a pressure sufficient to prevent the nucleated polymer melt from expanding to contact the surfaces of the exit section. If the exit section gap is too large relative to the nucleator exit gap then the out-diffusing gas is not sufficiently confined to form a gas blanket and does not provide sufficient pressure to prevent the polymer melt from contacting one or both of the exit section surfaces.

In certain embodiments, the dimension of radius 108 of the exit section is important for supporting the gas blanket. Typically, the radius is between 0.100 inch and 0.50 inch, and preferably between 0.125 inch and 0.25 inch. The minimum radius is determined by that required to sufficiently confine the gas blanket between the nucleated polymer melt and the exit section surfaces at the radius. The maximum radius is determined by that required to prevent the expanding nucleated polymer melt from contacting the surfaces at the radius and depends upon the expansion rate of the nucleated polymer melt.

In conjunction with the design of the die, the successful formation and support of the gas blanket depends upon a variety of processing parameters. Particularly critical processing parameters include pressure drop rate, flow rate and the weight percent of blowing agent, all of which generally have to be above a minimum value. The minimum values of the parameters vary for different processes and die designs, and can be determined by experimentation.

The transition when operating at conditions insufficient for providing a gas blanket to conditions sufficient for providing a gas blanket are readily apparent. In particular, the visual appearance of the extruded product dramatically improves when the gas blanket is generated, as described above. In addition, the transition typically can be heard. When the gas blanket is formed, it is possible to hear a constant and consistent whistling sound believed to result from the out-diffused gas escaping from the gap between the polymer melt and the die surfaces.

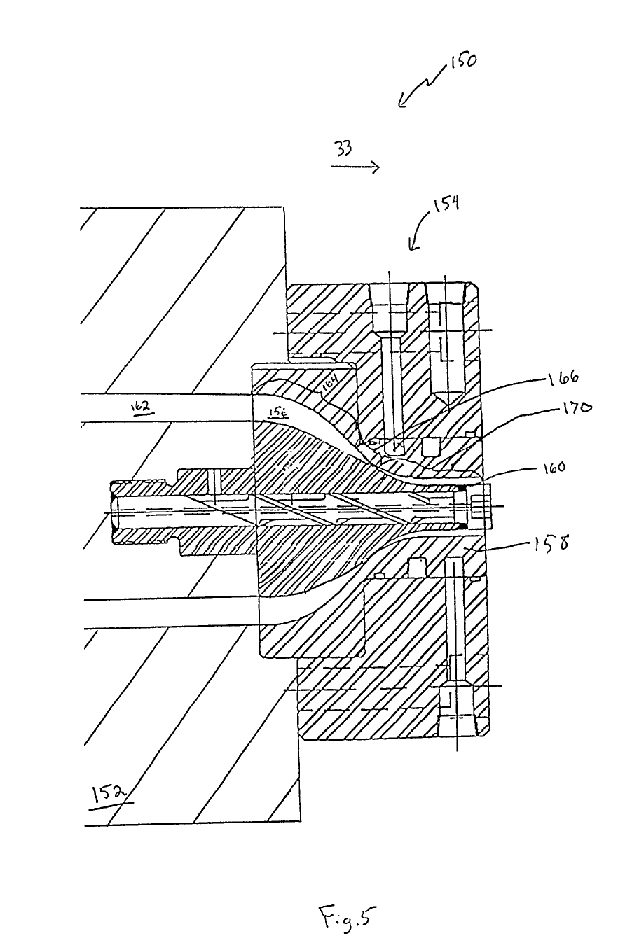

Referring to FIG. 5, an annular polymer processing die 150, according to another embodiment of the invention, is illustrated schematically. Die 150 includes an annular die body 152 attachable to a downstream end of an extruder and an annular dip lip section 154 fixed to the downstream end of the die body. An annular passageway 156 is defined between an outer die lip 158 and an inner die lip 160, which as illustrated, also functions as a mandrel. Passageway 156 is fluidly connected to a flow channel 162 in the die body which is fluidly connected, when the die is attached to the extruder, to the polymer processing space to permit the polymeric material to flow from the extruder and through the die in downstream direction 33.

The inner die lip and outer die lip are, respectively, attached to the die body which fixes the position of the inner die lip relative to the outer die lip to define the dimensions of passageway 156. The passageway includes a series of annular sections. An entrance section 164, connected at an upstream end to the flow channel within the die body, has an outer diameter that decreases in cross-sectional area in a downstream direction. The dimensions of the entrance section are designed to provide an insignificant pressure drop when the polymeric material and blowing agent solution passes therethrough. Immediately downstream of the entrance section, passageway 156 includes a nucleator section 166 having an outer diameter and a gap that both decrease in a downstream direction. The nucleator exit gap, thus, defines the minimum gap in the nucleator section. The decrease in gap and in outer diameter both function to decrease the cross-sectional area of the nucleator section which, as described above, provides a high pressure drop rate. Downstream of the nucleator section, the passageway includes an exit section 170. The exit section has a constant gap across its entire length.

To generate and support the gas blanket, the nucleator section and the exit section are specifically designed. The nucleator section converges to create a high pressure drop rate having a maximum value when polymeric material passes through the nucleator exit gap. Preferably, the nucleator exit gap is sized to provide a pressure drop rate of greater than 0.5 GPa/s, in some embodiments greater than 1.0 GPa/s, in some embodiments greater than 1.5 GPa/s or even higher. The exit section gap, as described above is between 5 and 20 times greater, and preferably between 8 and 12 times greater, than the nucleator exit gap.

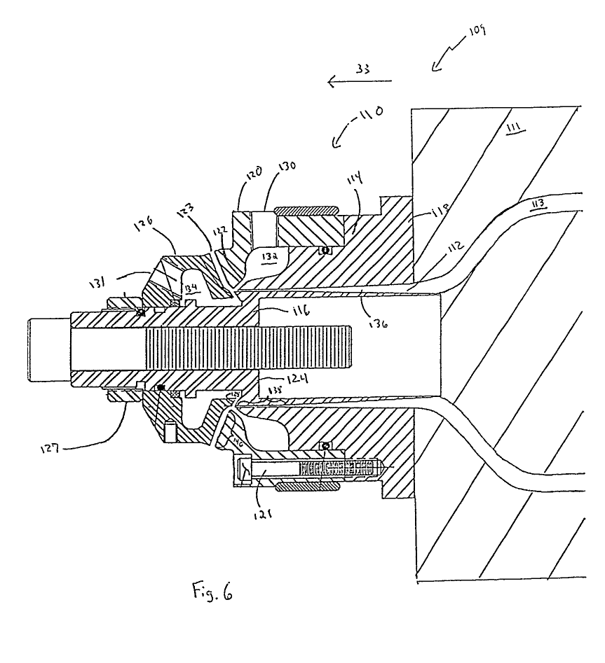

Referring to FIGS. 6 and 6A, an annular polymer processing die 109 according to another embodiment of the invention is illustrated schematically. An annular die body 111 of the polymer processing die is attachable, at its upstream end (not illustrated), to a downstream end of an extruder. A die lip section 110 is fixed to a downstream end of the die body. The die lip section includes an annular passageway 112 therethrough which is fluidly connected to the polymer processing space within the extruder via a flow channel 113 in the die body. Polymer processing die 109 is configured to permit the introduction of gas from an external source into the passageway to generate the gas blanket, as described further below, when arranged as illustrated in FIG. 6 and to prevent the introduction of gas from an external source into the passageway when arranged as illustrated in FIG. 6A when generation of a gas blanket is not desired (e.g. during startup of the process).

The passageway in the die lip section is defined between an outer die lip 114 and an inner die lip 116. The outer and inner die lips are respectively attached to the die body to fix certain dimensions of the passageway. Passageway 112 includes a series of annular sections having different functions. At its upstream end, the passageway includes an entrance section 136 which converges in a downstream direction. Immediately downstream of the entrance section, the passageway includes a nucleator section 138. The nucleator section can have a variety of configurations, as known in the art of microcellular processing, suitable for the production of microcellular material. As illustrated, nucleator section 138 is defined by parallel surfaces to provide a constant nucleator gap. In other embodiments, the nucleator section may include a converging or a diverging gap. As described above, converging nucleator sections decrease in cross-sectional area in a downstream direction and provide relatively high pressure drop rates. Channel 112 includes, downstream of the nucleator section, an exit section 140 which diverges from the nucleator section. The exit section, as illustrated, has a constant gap across its length that is larger than the nucleator section gap. In other embodiments, the exit section may converge or diverge. The exit section gap is sized to support the gas blanket and is determined, in part, by the thickness of the foam and the flow rate of the external gas. At its downstream end, the exit section defines an outlet 123 of the die.

The outer die lip is composed of a fixed section 118 secured to the die body and a moveable section 120 attached to the fixed section via a screw 121. By loosening the screw, the moveable section may be moved laterally in a downstream direction between a first position (FIG. 6) of contact with the fixed section and a second position (FIG. 6A) removed from the fixed section to provide a gap 122 therebetween. Similarly, the inner die lip also includes a fixed section 124 and a moveable section 126. The fixed section extends through an inner diameter of a moveable section 126 and is attached to the die body. The position of the moveable section relative to the fixed section is set by a nut 127 screwed onto the outer diameter of the moveable section downstream of the moveable section. The nut, when tightened, forces the moveable section into a first position (FIG. 6A) of contact with the fixed section. Loosening the nut permits lateral motion in a downstream direction of the moveable section relative to the fixed section to a second position (FIG. 6) to provide a gap 128 therebetween.

Moveable sections 120, 126 include respective gas port 130, 131 having inlets connectable to a gas source, for example compressed air, and outlets which respectively release the gas into an outer cavity 132 and an inner cavity 134. The outer cavity extends annularly between moveable section 120 and fixed section 114 to distribute the gas uniformly within the outer die lip. The inner cavity extends annularly between moveable section 126 and fixed section 116 to distribute the gas uniformly within the inner die lip. When provided, gap 122 connects the inner cavity to the passageway to provide a flow path for the gas that forms the portion of the gas blanket that prevents the nucleated polymer melt from contacting surfaces of moveable section 126. Gap 128, when present, connects the outer cavity to the passageway to provide a flow path for the gas that forms the portion of the gas blanket that prevents the nucleated polymer melt from contacting surfaces of moveable section 120. As illustrated, and preferably, gaps 128 and 122 connect with the passageway in the exit channel section. In other embodiments, gaps 128 and 122 may connect to other sections of the passageway.

During typical operation, moveable sections 120, 126 initially are in a first position of contact with respective fixed sections 114, 124 as illustrated in FIG. 6A. When it is desired to form a gas blanket, sections 120, 126 are moved relative to fixed sections 114, 116 to respectively provide gaps 122, 128 as described above and illustrated in FIG. 6. Pressurized gas from the external gas source distributed within cavities 132, 134 flows through gaps 122, 128 respectively into passageway 112 to provide a continuous gas blanket. The gas is maintained at a higher pressure than the polymeric melt in the passageway to prevent polymeric melt from flowing out of the passageways through the respective gaps. A gas blanket is continually formed from the pressurized gas which forces the nucleated polymer melt away from the surfaces of the exit section. The gas blanket in this embodiment has the same function as the gas blanket in the above-described embodiments. Contact between the nucleated polymer melt and at least a portion of the exit section surfaces is thus prevented. The gas blanket prevents contact between the nucleated polymer melt and the exit section surfaces at least at the outlet of the die, preferably within 1 cm of the outlet, and more preferably along the entire length of the exit section. In certain embodiments, contact between one side of the polymer melt and the die surfaces can be prevented while contact between the other side of the polymer melt and the die surfaces is permitted.

Because polymer processing die 109 does not rely upon the generation of the gas blanket from gas diffusing out of surfaces of the polymer melt, the dimensions of the nucleator section and the exit section can be designed with less stringent requirements than the above-described dies illustrated in FIGS. 3 and 5. The nucleator section may have a constant gap and high pressure drop rates are not required. Generally, the minimum pressure drop rate to form microcellular foam material, is that which creates sufficient nucleation and can be as low as 0.1 GPa/s. In addition to microcellular foam processing, die 109 may be used to process conventional foams utilizing a gas blanket. When processing conventional foams pressure drop rates of much lower than 0.1 GPa/s may be used. The gap exit section of die 109, in all cases, does not have to be between 5 and 20 times the nucleator section gap as described in the embodiments of FIGS. 3 and 5, to support the gas blanket. The gas flow rate may be adjusted to permit support of a gas blanket over a greater range of exit section gaps relative to nucleator section gaps.

The function and advantages of the above-described embodiment of the present invention will be more fully understood from the examples below. The following examples are intended to illustrate the benefits of the present invention, but do not exemplify the full scope of the invention. The examples below demonstrate advantages of forming a gas blanket that prevents contact between the polymer melt and surfaces of the die during extrusion.

### EXAMPLE 1

### Basic Extrusion System

A tandem extrusion line including a 2½ in 32:1 L/D single screw primary extruder (Akron Extruders, Canal Fulton, Ohio) and a 3 in 36:1 L/D single screw secondary extruder (Akron Extruders, Canal Fulton, Ohio) was arranged in a parallel configuration. An injection system for the injection of CO₂ into the secondary was placed at approximately 8 diameters from the inlet to the secondary. The injection system included 4 equally spaced circumferential, radially-positioned ports, each port including 176 orifices, each orifice of 0.02 inch diameter, for a total of 704 orifices. The injection system included an air actuated control valve to precisely meter a mass flow rate of blowing agent at rates from 0.2 to 12 lbs/hr at pressures up to 5500 psi.

The screw of the primary extruder was specially designed screw to provide feeding, melting and mixing of the solid plastic pellets followed by a mixing section for the dispersion of blowing agent in the polymer. The outlet of this primary extruder was connected to the inlet of the secondary extruder using a transfer pipe of about 24 inches in length.

The secondary extruder was equipped with specially designed deep channel, multi-flighted screw design to cool the polymer and maintain the pressure profile of the microcellular material precursor, between injection of blowing agent and the die.

### EXAMPLE 2

### Basic Extrusion System with Comparative Die

An annular die similar to the die illustrated in FIG. 37 of commonly-owned International Patent Application Ser. No. PCT/US97/15088, filed Aug. 26, 1997 was used in the system of Example 1. The die includes a nucleating pathway having a length of 0.560 inch and a constant gap of 0.026 inch. A radius of 0.125 inch is defined by the junction of the nucleating pathway and a divergent exit channel. The exit channel has a constant gap of 0.070 inch.

The processing parameters are summarized in the table below. The melt temperature was measured at the die body. The material used was crystal polystyrene (Fina 585BPO, melt flow rate=1.50 g/10 min) in pelletized form. CO₂ was the blowing agent.

| Die Pressure | dP/dt Calcu- | Wt. % Blowing | Flow Rate | Melt. Temp |
|---|---|---|---|---|
| (psi) | lated (Gpa/s) | Agent | (lbs/hr) | (° F.) |
| 2190 | 0.27 | 7 | 200 | 265-275 |

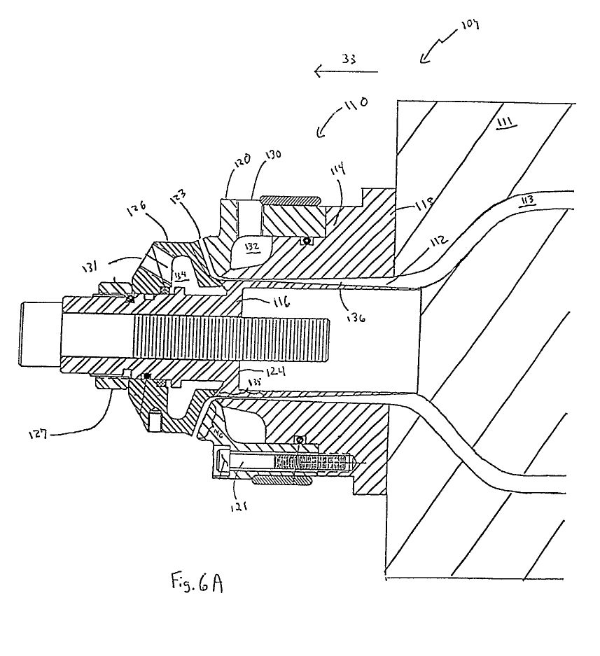

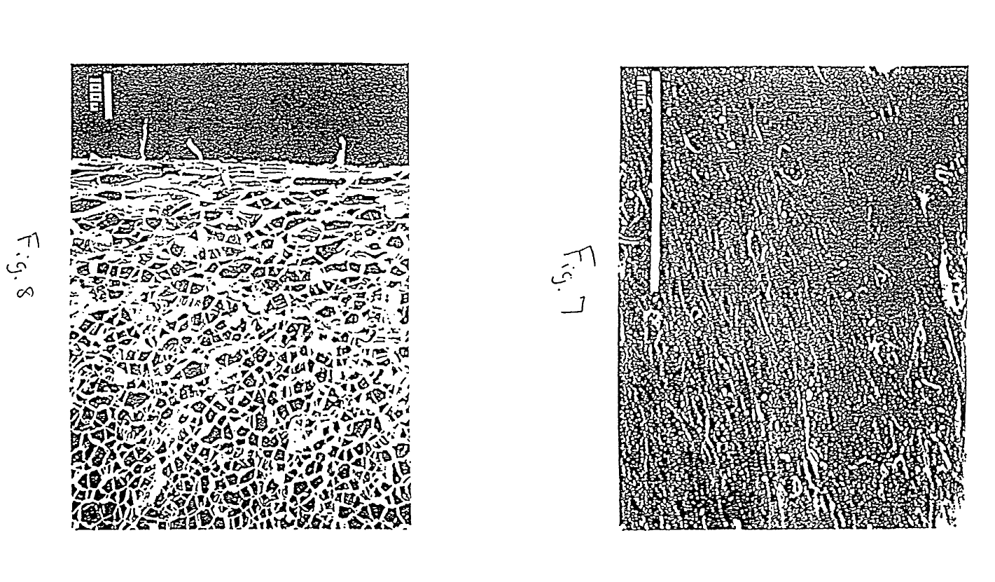

FIGS. 7 and 8 are photocopies of respective SEM photos of the surface (at 50× magnification) and cross-section (at 100× magnification) of the sample produced according to Example 2. As illustrated in the SEM photo, the surface of the sample includes minor defects (e.g. tearing) resulting from contact between the polymer melt and die surfaces. The cross-section shows the relative non-uniformity of the cell structure between the center of the sample and the surface. The average cell size at the surface is approximately 40 microns as compared to 30 microns at the center. In particular, at the surface some cells are ruptured and elongated. It is noted that though the material illustrated in FIGS. 7 and 8 has smooth surfaces when compared to many other conventional foams, the material produced according to the present invention provides material having dramatically smoother surfaces as illustrated in the Example below.

### EXAMPLE 3

### Basic Extrusion System with Die Configured to Generate and Support A Gas Blanket

An annular die similar to the die illustrated in FIG. 3 was used in the system of Example 1. The die included a converging nucleating pathway having an included convergence angle of 5°, a length of 0.750 inch, and a gap of 0.013 inch at the exit of the nucleating pathway. A radius of 0.25 of the exit channel was defined by the outer die as illustrated in FIG. 3. The exit channel had a gap of 0.070 inch. The material used was crystal polystyrene (Fina 585BPO, melt flow rate=1.50 g/10 min.) in pelletized form. CO₂ was the blowing agent.

| Die Pressure | dP/dt Calcu- | Wt. % Blowing | Flow Rate | Melt Temp. |
|---|---|---|---|---|
| (psi) | lated (GPa/s) | Agent | (lbs/hr) | (° F.) |
| 2600 | 1.5 | 7 | 200 | 265-275 |

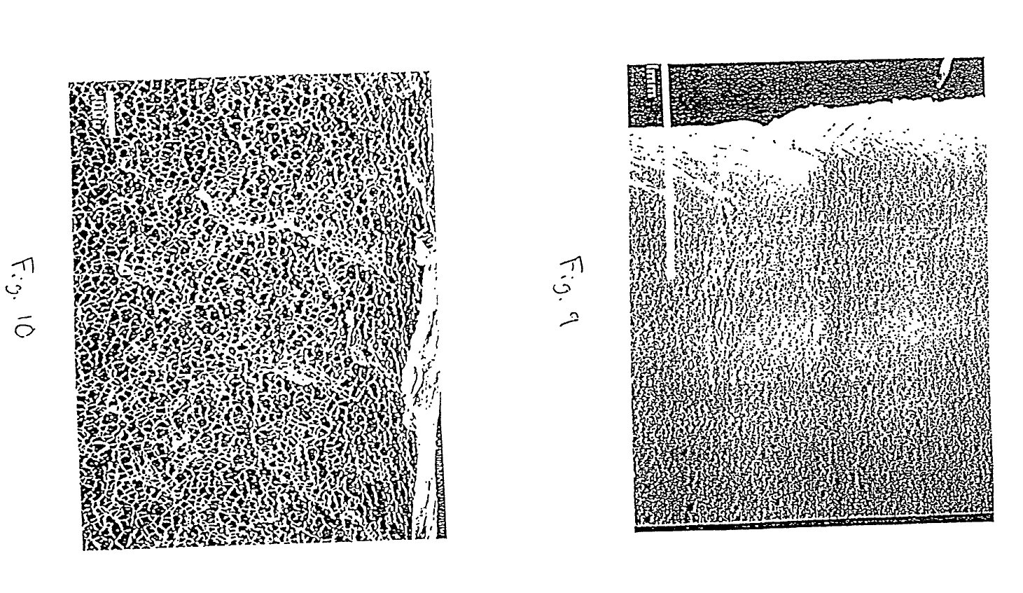

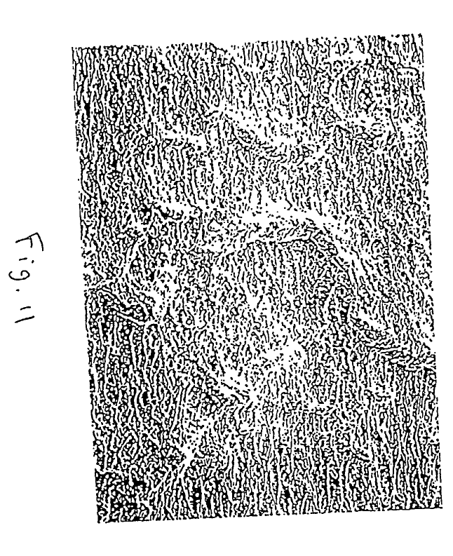

FIGS. 9 and 10 are photocopies of respective SEM photos of the surface (at 50× magnification) and the cross-section (at 100× magnification) of the sample produced according to Example 3. The surface of the sample is ultra-smooth and generally free of surface defects. The cell structure is uniform across the cross-section of the sample with the average cell size of 26 microns at the center and 28 microns at the surface.

### EXAMPLE 4

### Basic Extrusion System

An NRM (Pawcatuck, Conn.) 4.5 inch 44:1 L/D long single extrusion line was equipped with an injection system for injection of CO₂ placed at a distance of approximately 25 diameters from the feed section. The injection system included 4 equally-spaced circumferentially, radially-positioned ports, each port including 417 orifices, each orifice of 0.02 inch diameter, for a total of 1668 orifices.

The extruder was equipped with a two-stage screw including conventional first-stage feed, barrier flight transition, and metering sections, followed by a multi-flighted (six flights) mixing section for blowing agent dispersion. The screw was designed for high-pressure injection of blowing agent with minimized pressure drop between the first-stage metering section and point of blowing agent injection. The second stage of the screw included a mixing section having 6 flights unbroken at the injection ports so that the orifices were wiped (opened and closed) by the flights. At a screw speed of 80 RPM each orifice was wiped by a flight at a frequency of 8 wipes per second. The mixing section and injection system allowed for very rapid establishment of a single-phase solution of blowing agent and polymeric material.

The injection system included an air-actuated control valve to precisely meter a mass flow rate of blowing agent at rates from 0.2 to 50 lbs/hr at pressures up to 5500 psi.

The second stage of the screw was also equipped with a deep channel, three-flighted cooling section with broken flights, which provided the ability to cool the polymer melt stream.

The system included, at the end of the extruder, a die adapter equipped with taps for measurement of melt temperature and pressure just prior to entry into the die.

### EXAMPLE 5

### Basic Extrusion System with Comparative Die

A cylindrical annular die having an outer diameter of 0.648 inch, an inner diameter of 0.600 inch, a constant die gap of 0.024 inch, and a die land of 0.84 inch was attached to the die adapter in the system of Example 4. PVC pellets approximately _ weight % filler, highly plasticized were used. CO₂ was the blowing agent. The system was run at the following processing parameters.

| Die Pressure | dP/dt Calcu- | Wt. % Blowing | Flow Rate | Melt Temp. |
|---|---|---|---|---|
| (psi) | lated (GPa/s) | Agent | (lbs/hr) | (° F.) |
| 3290 | 1.3 | 2.1 | 290 | 279 |

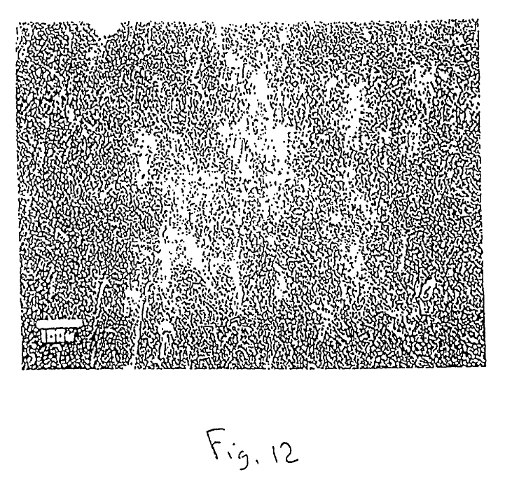

FIG. 11 is a photocopy of an SEM photo of the surface (at 71× magnification) of the material produced in Example 5. The surface includes defects including surface tearing and holes.

### EXAMPLE 6

### Basic Extrusion System with Die Configured to Generate and Support A Gas Blanket

A die similar to the die illustrated schematically in FIG. 5 was attached to the die adapter in the system of Example 4.

The nucleating gap was set at 0.012 inch. The exit section gap was set at 0.022 inch and the exit section length was set at 0.860 inch.

The same material and blowing agent were used as in Example 5. The system was run at the following processing parameters.

| Die Pressure | dP/dt Calcu- | Wt. % Blowing | Flow Rate | Melt Temp. |
|---|---|---|---|---|
| (psi) | lated (GPa/s) | Agent | (lbs/hr) | (° F.) |
| 3730 | 1.1 | 1.5 | 115 | 249 |

FIG. 12 is a photocopy of an SEM photo of the surface (at 100× magnification) of the material produced in Example 4. The surface is ultra-smooth and, generally, free of defects.

Those skilled in the art would readily appreciate that all parameters listed herein are meant to be exemplary and that actual parameters will depend upon specific application for which the methods and apparatuses of the invention are used. It is, therefore, to be understood that the foregoing embodiments are presented by way of example only and that, within the scope of the appended claims and equivalents thereto, the invention may be practiced otherwise than as specifically described.

What is claimed is:

1. A method of forming a polymeric article comprising:
forming a solution of polymer melt and blowing agent within a polymer processing space between a processing screw and a barrel of an extruder; and
extruding the solution of polymer and blowing agent through a die having a passageway, defined by internal die surfaces, fluidly connected to the polymer processing space while forming a gas blanket that separates the polymer melt from at least a portion of the internal die surfaces at an outlet of the die.

2. The method of claim 1, wherein the gas blanket comprises blowing agent diffused out of the polymer melt.

3. The method of claim 1, further comprising nucleating the polymer melt and blowing agent solution by passing the solution through a section of the passageway including a nucleating gap.

4. The method of claim 3, comprising nucleating the polymer melt and blowing agent at a rate of at least 0.5 GPa/s.

5. The method of claim 3, comprising nucleating the polymer melt and blowing agent at a rate of at least 1.0 GPa/s.

6. The method of claim 3, comprising nucleating the polymer melt and blowing agent at a rate of at least 1.5 GPa/s.

7. The method of claim 3, comprising nucleating the polymer melt and blowing agent at a rate of at least 2.0 GPa/s.

8. The method of claim 3, wherein the section of the passageway has a cross-sectional area that decreases in a downstream direction.

9. The method of claim 3 wherein the nucleating gap is between 5 and 20 times an exit gap defined by the outlet of the die.

10. The method of claim 3, wherein the nucleating gap is between 8 and 12 times an exit gap defined by the outlet of the die.

11. The method of claim 1, wherein the gas blanket completely separates the polymer melt from the internal die surfaces throughout the entire final 1 cm before the outlet.

12. The method of claim 1, comprising forming the gas blanket continuously.

13. The method of claim 1, comprising forming the gas blanket uniformly between the polymer melt and at least a portion of the internal die surfaces defining the outlet of the die.

14. The method of claim 1, wherein forming the gas blanket occurs after nucleating the polymer melt and blowing agent solution and prior to extruding the polymer melt through the outlet of the die.

15. The method of claim 1, wherein the gas blanket comprises a gas from a gas source external of the extruder.

16. The method of claim 1, wherein the polymeric material comprises polystyrene.

17. The method of claim 1, further comprising forming a microcellular material.

18. The method of claim 17, wherein the microcellular material has a void fraction between 0.80 and 0.98.

19. The method of claim 17, wherein the microcellular material has void fraction between 0.90 and 0.98.

20. The method of claim 17, wherein the microcellular material has a void fraction between 0.95 and 0.98.

21. A method of forming a polymeric article comprising:
forming a solution of polymer melt and blowing agent within a polymer processing space between a processing screw and a barrel of an extruder; and
extruding, through a die outlet of the extruder, a polymeric article in the shape of an extrudate corresponding to the shape of the die outlet by maintaining pressure on an exterior surface of the polymer melt within the die and then releasing the pressure as the polymer melt exits the die outlet and hardens to form the extrudate, without allowing the polymer melt to contact interior surfaces of the die within 1 cm of the die outlet.

22. A polymer processing die comprising:
an inlet designed to receive a solution of polymer melt and blowing agent from an outlet of an extruder;
a nucleating passageway fluidly connected to the inlet having dimensions designed to nucleate the solution of polymer melt and blowing agent; and
an exit passageway fluidly connected to the nucleating pathway having dimensions designed to support a gas blanket between surfaces defining the exit passageway and surfaces of the nucleated polymer melt.

23. The polymer processing die of claim 22, wherein the nucleating passageway has a cross-sectional area that decreases in a downstream direction.

24. The polymer processing die of claim 22, wherein the nucleating passageway has dimensions designed to nucleate the solution of polymer melt and blowing agent at a rate of at least 0.5 GPa/s.

25. The polymer processing die of claim 22, wherein the nucleating passageway has dimensions designed to nucleate the solution of polymer melt and blowing agent at a rate of at least 1.0 GPa/s.

26. The polymer processing die of claim 22, wherein the nucleating passageway has dimensions designed to nucleate the solution of polymer melt and blowing agent at a rate of at least 1.5 GPa/s.

27. The polymer processing die of claim 22, wherein the nucleating passageway has dimensions designed to nucleate the solution of polymer melt and blowing agent at a rate of at least 2.0 GPa/s.

28. The polymer processing die of claim 22, wherein the exit passageway has a gap between 5 and 20 times greater than a gap of the nucleating passageway.

29. The polymer processing die of claim 22, wherein the exit passageway has a gap between 8 and 12 times greater than a gap of the nucleating passageway.

30. The polymer processing die of claim 22, wherein the nucleating passageway defines an axis and the exit passageway defines an axis that intersects the nucleating passageway axis at a divergent angle.

31. The polymer processing die of claim 22, wherein a die section at the fluid connection between the nucleating passageway and the exit passageway includes a radius between 0.100 inch and 0.50 inch.

32. The polymer processing die of claim 22, wherein a die section at the fluid connection between the nucleating passageway and the exit passageway includes a radius between 0.125 inch and 0.25 inch.

33. The polymer processing die of claim 22, wherein the exit passageway has a length of 0.5 inch to 1.5 inch.

34. The polymer processing die of claim 22, further comprising an inlet port constructed and arranged to provide passage for a gas, from an external gas source, to an internal passageway of the die.

35. The polymer processing die of claim 34, wherein the internal passageway of the die comprises the exit passageway.

36. A polymer processing die comprising:
a die inlet positionable in relation to an outlet of an extruder to receive a single-phase solution of polymer melt and blowing agent from the extruder outlet;
a die outlet; and
a passageway connecting the die inlet with the die outlet, the passageway including a first, upstream portion defining a nucleating pathway having a cross-sectional area and length designed to nucleate the solution of polymer melt and blowing agent and a second, downstream portion, between the first portion and the die outlet, of a second cross-sectional area greater than the first cross-sectional area, the second cross-sectional area selected such that under conditions of flow of the single-phase solution of polymer melt and blowing agent within the nucleating pathway set to nucleate the single-phase solution, a gas blanket is formed between surfaces defining the interior surface of the second portion and surfaces of the nucleated polymer melt of sufficient pressure to confine the polymer melt and to prevent contact between the polymer melt and the interior surface of the second section.

37. An article comprising:
a microcellular material having an average cell size of less than 100 microns and the variation of cell size across the cross-section of the material being less than 20% of the average cell size,
the material including a skin layer having a thickness of less than 1 micron defining an outer surface of the material.

38. The article of claim 37, wherein the outer surface is visibly free of surface defects.

39. The article of claim 37, wherein the skin layer has a thickness of less than 0.1 micron.

40. The article of claim 37, wherein the microcellular material has an average cell size of less than 50 microns.

41. The article of claim 37, wherein the microcellular material has an average cell size of less than 30 microns.

42. The article of claim 37, wherein the microcellular material has a void fraction between 0.80 and 0.98.

43. The article of claim 37, wherein the microcellular material has a void fraction between 0.90 and 0.98.

44. The article of claim 37, wherein the microcellular material has a void fraction between 0.95 and 0.98.

45. The article of claim 37, wherein the microcellular material comprises polystyrene.

46. An article produced according to the method of claim 1.
